(19) United States
(12) Patent Application Publication
(10) Pub. No.: US 2019/0039825 A1
(43) Pub. Date: Feb. 7, 2019

(54) Wastebasket Stand

(71) Applicant: Richard Matthew Leonard, Murfreesboro, TN (US)

(72) Inventor: Richard Matthew Leonard, Murfreesboro, TN (US)

(21) Appl. No.: 16/053,731

(22) Filed: Aug. 2, 2018

Related U.S. Application Data
(60) Provisional application No. 62/540,172, filed on Aug. 2, 2017.

(51) Int. Cl. B65F 1/14; F16M 11/26; F16M 11/42

(52) U.S. Cl. CPC B65F 1/141; F16M 11/26; F21S 9/02; B65F 1/1468; F16M 11/42

(57) ABSTRACT

A wastebasket stand device is an apparatus that enables a user to contain and support a wastebasket during general use and to facilitate removal of the garbage bag. A properly-sized wastebasket is securely and detachably attached to the base panel of the apparatus using the basket-attachment mechanism. The apparatus allows the user to conveniently hold the device in place while pulling the heavy and full garbage bag out of the wastebasket. The height-adjustment poles located in the support structure allows the user to efficiently adjust the apparatus to the desired height, thus to avoid arms and body strain, and potential back injury. Furthermore, the apparatus includes either grips or lockable wheels to allow the user to easily move the apparatus without damaging any flooring materials.

The current application claims a priority to the U.S. Provisional Patent application serial number 62/540,172 filed on Aug. 02, 2017.

### FIELD OF THE INVENTION

The present invention relates generally to a waste device. More specifically, the present invention relates to a wastebasket stand device that enables a user to contain and support their wastebasket during general use and facilitates removal of the garbage bag contained within the wastebasket.

### BACKGROUND OF THE INVENTION

Particularly in the past several decades, the amount of waste created on a daily basis by the average consumer has increased exponentially. This increase is due to the packaging processes that are ever-increasing in complexity and required material resources, increased food covering and packaging, and the generally wasteful consumer mentality, among other things. As a result, waste baskets fill relatively quickly. Within homes, food by-products, expired or otherwise damaged goods, and other such generally heavy waste often fill garbage bags contained in large baskets. The bags within these baskets quickly become weighed down with garbage.

Unfortunately, most garbage bags in waste baskets are easy to fill, but difficult to remove once full. The weight creates a vacuum between the bottom of the bag and the bottom of the basket, sealed off by the expanding sides of the full bag. Such an arrangement can result in excessive strain on the user's hands, arms and back, and if not removed carefully. The excessive strain can cause some garbage bags to tear, spewing their contents into the waste baskets. The basket or bin itself may tip or fall in the process of bag removal. To remove bags, the user often has to press the wastebasket between the user's legs to hold it in place while pulling upward on the garbage bag. What is needed is a device that can reduce the strain in a user's back by providing leverage with which to remove the bag. Further useful would be a device that enables a user to hold a wastebasket securely in place during use and during removal of garbage bags.

The present invention addresses these issues. The wastebasket stand is a solid device that supports a wastebasket or garbage bin. The present invention comprises a foot-receiving channel (or an open cut) and a grasping panel. A user may conveniently place his or her foot into the foot-receiving and resting on the grasping panel to hold the present invention in place. The wastebasket, being held in place by the basket-attachment mechanism including, but not limited to, adhesive strips, wing head threaded rods with end stops, and plastic bonding agent, etc., does not leave the ground. Instead, the user finds that it is easier to separate bag from the basket, particularly since the user no longer has to trap the bin in place between the user's legs.

### BRIEF DESCRIPTION OF THE DRAWINGS

FIG. 1 is an isometric perspective view of the present invention.

FIG. 2 is a bottom right perspective view of the present invention.

FIG. 3 is a front view of the present invention.

FIG. 4 is a rear view of the present invention.

FIG. 5 is a top view of the present invention.

FIG. 6 is a diagram the illumination assembly of the present invention.

### DETAIL DESCRIPTIONS OF THE INVENTION

All illustrations of the drawings are for the purpose of describing selected versions of the present invention and are not intended to limit the scope of the present invention.

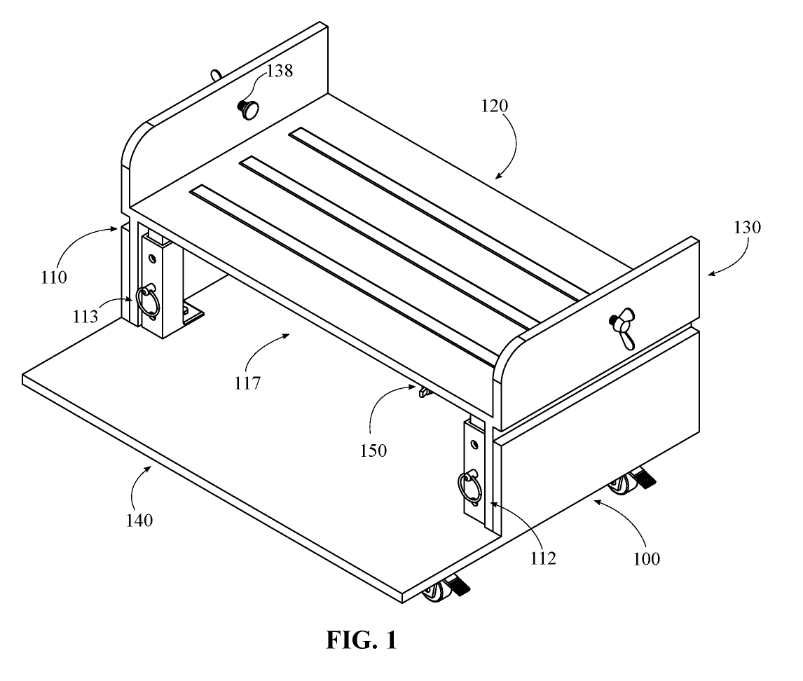

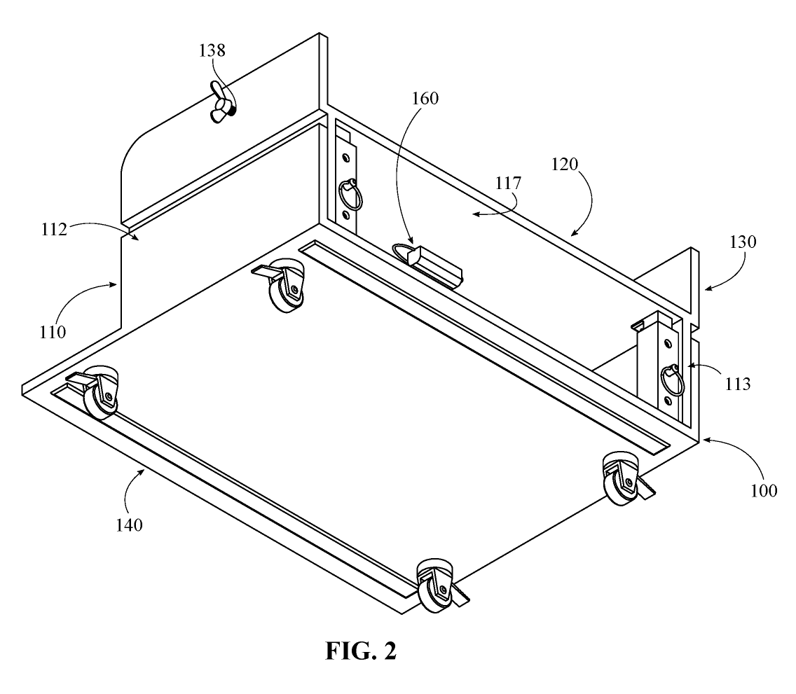

As seen in FIGS. 1 and 2, the present invention is a wastebasket stand that holds a waste collection container in place during the process of removing heavy or full garbage bags from the container. The garbage, trash, and waste bins, cans, containers, or receptacles, herein referred to as wastebaskets, or baskets, are held in place within the present invention while the user applies bodyweight pressure to the grasping panel 100, enabling the user to remove the bag from the wastebasket without trapping the wastebasket, or otherwise struggling to keep the wastebasket in place. The wastebasket stand comprises a grasping panel 100, a support structure 110, a base panel 120, and a basket attachment mechanism 130. The grasping panel 100 is connected adjacent to the support structure 110 providing a solid support for the structure of the wastebasket stand. The base panel 120 is then connected to the support structure 110, parallelly opposite to the grasping panel 100 providing support for the wastebasket. The basket-attachment mechanism 130 is mounted on to the base panel 120 and provides detachable attachment of the wastebasket onto the base panel 120.

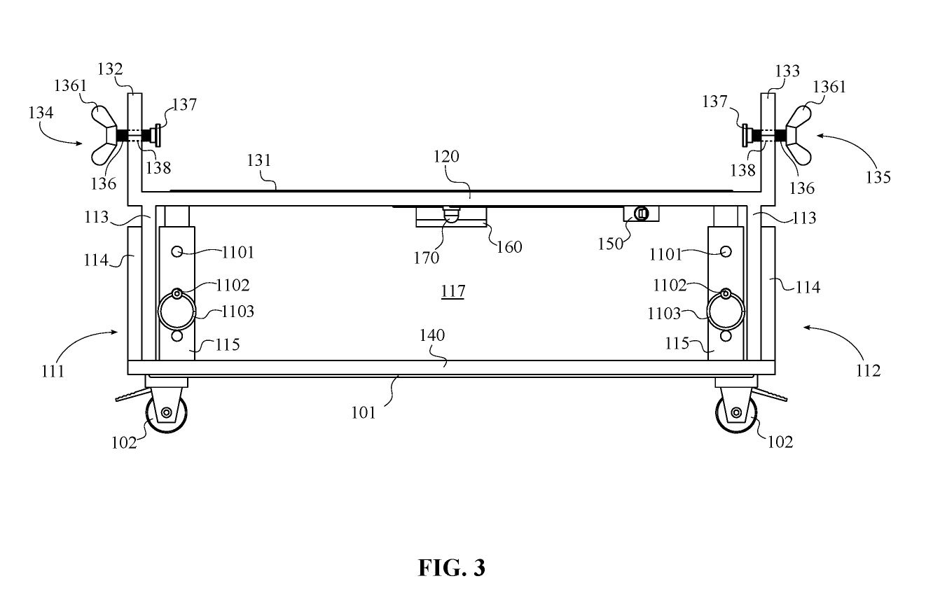

As seen in FIGS. 1-3, the grasping panel 100, the support structure 110, and the base panel 120 form a foot-receiving channel 117 for the user conveniently holding the wastebasket stand steady while pulling the garbage bag contained in the wastebasket, which is attached to the base panel 120 using the basket attachment mechanism 130. In one embodiment of the present invention, a ledge 140, may be connected to the grasping panel 100, extending the foot-receiving channel for increased space to allow the user to conveniently hold wastebasket in place. The ledge 140 is positioned coplanar with and connected adjacent to the grasping panel 100. In another embodiment, the ledge 140 is part of the grasping panel 140.

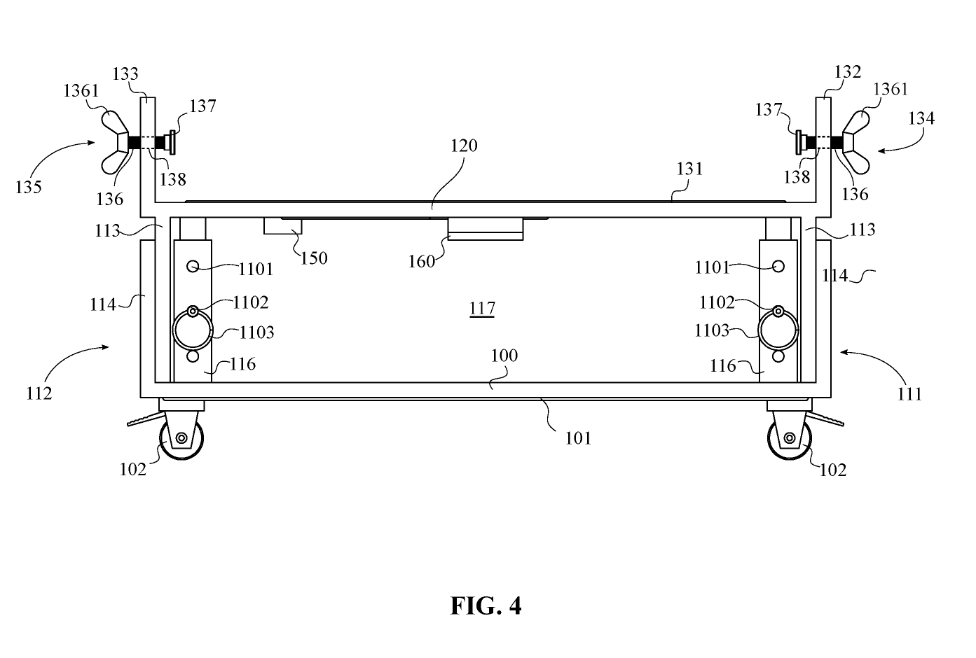

As seen in FIGS. 1-4, the support structure 110 comprises a first support 111 and a second support 112, located across the grasping panel 100 and opposite to each other. The first support 111 and a second support 112, are positioned offset to each other and mounted in between the grasping panel 100 and the base panel 120. The support structure 110 provides not only support to the base panel 120 with the attached wastebasket, but also a structure and method for the user to adjust the wastebasket stand to a desired height for efficiently pulling the full and heavy garbage bag out of the wastebasket. Both the first support 111 and the second support 112 are perpendicular to the grasping panel 100 and the base panel 120, thus creating the foot-receiving channel 117 while allowing the base panel 120 to move up and down when the user is adjusting the height. The first support 111 and the second support 112 each comprise an inner wall 113, an outer wall 114, a first height-adjustment pole 115, and a second height-adjustment pole 116. The inner wall 113 is perpendicularly attached to the base panel 120 and positioned adjacent to the outer wall 114. The inner wall 113 moves up and down along the outer wall 114 when the height is being adjusted. The inner wall 113 also rests on the grasping panel 100 when base panel is at the lowest height. The outer wall 114 is perpendicularly attached to the grasping panel 100 and is parallel to the inner wall 113. To facilitate the height adjustment, the preferred embodiment of the present invention comprises the first height-adjustment pole 115 and the second height-adjustment pole 116 positioned offset from the outer wall 114. The first height-adjustment pole 115 and the second height-adjustment pole 116 are terminally mounted to the grasping panel 100 and the base panel 120, opposite to each other across the outer wall 114. The inner wall 113 is slidably engaged in between the first height-adjustable pole 115, the second height-adjustable pole 116, and the outer wall 114. The outer wall 114 is stationary and provides a linear surface for the inner wall to slide against during height adjustment. The first height-adjustment pole 115 and the second height-adjustment pole 116 each comprise a plurality of holes 1101 which can be used with a pin 1102 to efficiently adjust the height of the base panel 120. The push pin may have a ring 1103 attached to the end opposite the pole for easy operation of the height adjustment. To adjust the height of the wastebasket stand, the user pulls out the pin 1102 with or without the ring 1103, raises the base panel 120, aligns the plurality of holes 1101, and pushes in the pin 1102 to lock the base panel 120 in place. This height adjustment is usually conducted before the wastebasket is attached to the base panel 120, or when the wastebasket is still empty. The preferred embodiment of the first height-adjustment pole 111 and the second height-adjustment pole 112 has square, or rectangular cross section. Other embodiments may have any other shapes such as circle, oval, etc.

The foot-receiving channel 117 is delineated by the first support 111, the second support 112, the grasping panel 100, and the base panel 120 as seen in FIGS. 1-4. The foot-receiving channel 117 provides sufficient space for the user to hold the wastebasket stand, preferably using a foot to apply pressure onto the grasping panel 100. Other suitable and desired methods may be used to hold the wastebasket stand in place while pulling the garbage bag contained in the wastebasket.

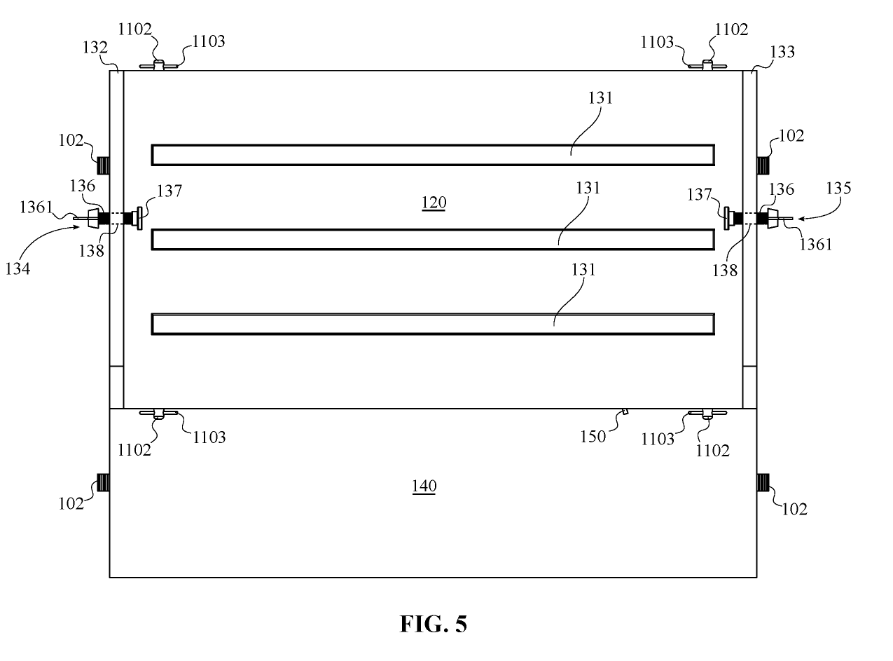

As seen in FIGS. 1, and 5, in one embodiment of the present invention, the basket-attachment mechanism 130 for detachably attaching the wastebasket comprises a plurality of adhesive strips 131 attached to the base panel 120 opposite the foot-receiving channel 117. The plurality of adhesive strips 131 is positioned parallel and offset from each other across the base panel 120. The plurality of adhesive strips 131 is distributed across the base panel 120 and can be double-sided adhesive tape with a plastic cover which is removed to attach the wastebasket.

In another embodiment of the present invention, as seen in FIGS. 1-5, the basket-attachment mechanism 130 for detachably attaching the wastebasket comprises a first wing 132, a second wing 133, a first linear actuator 134, and a second linear actuator 135. Both the first wing 132 and the second wing 133 are connected perpendicular and adjacent to the base panel 120 and opposite to each other. The wings provide support for the linear actuators that are used to detachably secure the wastebasket on the base panel 120. The first linear actuator 134 is operatively integrated into the first wing 132, while the second linear actuator 135 is operatively integrated into the second wing 133. Additionally, the first linear actuator 134 and the second linear actuator 135 are positioned collinear to each other. The first linear actuator 134, when engaged, provides an inward pressing force from the first wing 132, onto the peripheral surface of the wastebasket. Similarly, the engaged second linear actuator 135 provides an inward pressing force from the first wing 133, onto the peripheral surface of the wastebasket. With the first linear actuator 134 and second linear actuator 135 being engaged, the wastebasket is securely attached onto the base panel 120. Furthermore, in the preferred embodiment of the present invention, the first linear actuator 134 and the second linear actuator 135 each comprises a male-threaded rod 136, a wing head 1361, an end stopper 137, and a female-threaded hole 138. The wing head 1361 is terminally connected to the male-threaded rod 136. The end stopper 137 is terminally connected to the male-threaded rod 136 and opposite the wing head 1361. The end stopper 137 engages the outer surface of the wastebasket to hold it in place. It can be made of rubber, plastic, metal, and any other suitable materials. The female-threaded hole 138 of the first linear actuator 134 traverses through the first wing 132. The female-threaded hole 138 of the second actuator 134 traverses through the second wing 133. The wing head 1361 is engaged with the male-threaded rod 136 opposite the end stopper 137. The wing head 1361 provides a convenient means for the user to operator the linear actuators when securing the wastebasket onto the base panel 120. The wing head 1361 can have other suitable shapes such as circle, hexagon, etc. Additionally, the male-threaded rod 136 is engaged through the female-threaded hole 138.

In yet another embodiment of the present invention, the wastebasket may be securely attached to the base panel 120 using plastic bonding agent positioned on the base panel 120.

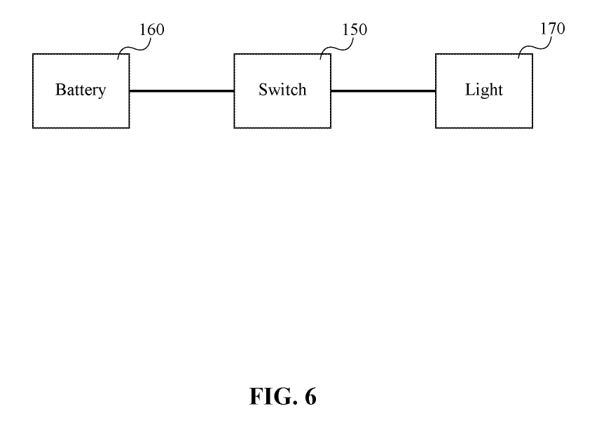

In the preferred embodiment of the present invention, as seen in FIGS. 1-5, the wastebasket stand further comprises a switch 150, a battery 160, and a light 170, positioned within the foot-receiving channel 117. The switch 150, battery 160, and light 170, are mounted onto the base panel 120, and the light 170 is electrically connected to the battery 160 through the switch 150 as seen in FIG. 6. In another embodiment, the light 170 and switch 150 may be directly connected to a wall receptacle without a battery. The light 170 provides illumination for the wastebasket stand at night or whenever the environment is dark. The light 170 may be a plurality of lights and arranged in a way to provide decoration such as blinking, or showing colored text, figure, etc.

As seen in FIGS. 2-4, in another embodiment, the wastebasket stand comprises a plurality of grips 101 attached to the grasping panel 100, opposite the foot-receiving channel 117 for the user to easily move the wastebasket stand around without damaging the flooring materials. The wastebasket stand, in yet another embodiment of the present invention, may comprise a plurality of lockable wheels 102, which is detachably attached to the grasping panel 100, opposite the foot-receiving channel 117. In one embodiment, four lockable wheels 102 are positioned on the gasping panel 100 with equally spacing to allow the user to move wastebasket stand and secure it in a desired location.

In the preferred usage of the present invention, the user acquires and situates a wastebasket stand. The user can optionally roll the wastebasket stand to the desired location and fix it using the plurality of lockable wheels 102. By adjusting the first height-adjustment pole 115 and second height-adjustment pole 116, the user achieves the desired height of the base panel 120. The user then places an appropriately sized wastebasket on the base panel 120. The user subsequently attaches the wastebasket to the wastebasket stand using the basket-attachment mechanism 130 and ensures that the wastebasket will not separate from the wastebasket stand. The user then places a garbage bag within the wastebasket and uses the wastebasket as usual. When the garbage bag is full, the user places a foot atop the grasping panel 100 and/or the ledge 140 and within the foot-receiving channel 117. The user then pulls the garbage bag from the wastebasket, while pressing down upon the grasping panel 100 and/or the ledge 140. This ensures the user to have adequate leverage to remove the garbage bag from the wastebasket. The present invention is prepared for subsequent use. The preferred embodiment of the present invention is made of plastic. But any other suitable materials can used for the wastebasket.

Although the invention has been explained in relation to its preferred embodiment, it is to be understood that many other possible modifications and variations can be made without departing from the spirit and scope of the invention as hereinafter claimed.

What is claimed is:

1. A wastebasket stand comprising:
a grasping panel;
a support structure;
a base panel;
a basket-attachment mechanism;
the grasping panel being connected adjacent to the support structure;
the base panel being connected adjacent to the support structure, opposite the grasping panel;
the grasping panel and the base panel being positioned parallel to each other; and
the basket-attachment mechanism being mounted onto the base panel.

2. The wastebasket stand as claimed in claim 1 comprising:
a ledge;
the ledge being positioned coplanar with the grasping panel; and
the ledge being connected adjacent to the grasping panel.

3. The wastebasket stand as claimed in claim 1 comprising:
the support structure comprising a first support and a second support;
the first support and the second support being positioned offset to each other;
the first support and the second support being mounted in between the grasping panel and the base panel; and
a foot-receiving channel being delineated by the first support, the second support, the grasping panel, and the base panel.

4. The wastebasket stand as claimed in claim 3 comprising:
the first support and the second support each comprising an inner wall, an outer wall, a first height-adjustable pole, and a second height-adjustable pole;
the outer wall being connected perpendicular to the grasping panel;
the inner wall being connected perpendicular to the base panel;
the first height-adjustable pole and the second height-adjustable pole being positioned offset from the outer wall;
the first height-adjustable pole and the second height-adjustable pole being positioned opposite to each other across the outer wall;
the first height-adjustable pole and the second height-adjustable pole being terminally connected to the grasping panel;
the first height-adjustable pole and the second height-adjustable pole being terminally connected to the base panel, opposite the grasping panel; and
the inner wall being slidably engaged in between the first height-adjustable pole, the second height-adjustable pole, and the outer wall.

5. The wastebasket stand as claimed in claim 3 comprising:
a switch;
a battery;
a light;
the switch, the battery, and the light being positioned within the foot-receiving channel;
the switch, the battery, and the light being mounted onto the base panel; and
the light being electrically connected to the battery through the switch.

6. The wastebasket stand as claimed in claim 1 comprising:
the basket-attachment mechanism comprising a plurality of adhesive strips;
the plurality of adhesive strips being positioned parallel and offset from each other; and
the plurality of the adhesive strips being distributed across the base panel.

7. The wastebasket stand as claimed in claim 1 comprising:
the basket-attachment mechanism comprising a plastic bonding agent; and
the plastic bonding agent being positioned on the base panel.

8. The wastebasket stand as claimed in claim 1 comprising:
the basket-attachment mechanism comprising a first wing, a second wing, a first linear actuator, and a second linear actuator;
the first wing being connected perpendicular and adjacent to the base panel;
the second wing being connected perpendicular and adjacent to the base panel, opposite the first wing;
the first linear actuator being operatively integrated into the first wing, wherein the first linear actuator is used to generate an inward pressing force from the first wing;
the second linear actuator being operatively integrated into the second wing, wherein the second linear actuator is used to generate an inward pressing force from the second wing; and
the first linear actuator and the second linear actuator being positioned collinear to each other.

9. The wastebasket stand as claimed in claim 8 comprising:
the first linear actuator and the second linear actuator each comprising a male-threaded rod, a wind head, a female-threaded hole, and an end stopper;
the wing head being terminally connected to the male-threaded rod;
the end stopper being terminally connected to the male-threaded rod, opposite the wing head;
the female-threaded hole of the first linear actuator traversing through the first wing;
the female-threaded hole of the second linear actuator traversing through the second wing; and
the male-threaded rod being engaged through the female-threaded hole.

10. The wastebasket stand as claimed in claim 1 comprising:
the grasping panel comprising a plurality of grips; and
the plurality of grips being attached on the grasping panel, opposite the foot-receiving channel.

11. The wastebasket stand as claimed in claim 1 comprising:
the grasping panel comprising a plurality of lockable wheels; and
the plurality of lockable wheels being detachably attached on the grasping panel, opposite the foot-receiving channel.

12. A wastebasket stand comprising:
a grasping panel;
a support structure;
a base panel;
a basket-attachment mechanism;
a support structure comprising a first support and a second support;
a foot-receiving channel being delineated by the first support, the second support, the grasping panel, and the base panel;
the grasping panel being connected adjacent to the support structure;
the base panel being connected adjacent to the support structure, opposite the grasping panel;
the grasping panel and the base panel being positioned parallel to each other;
the basket-attachment mechanism being mounted onto the base panel;
the first support and the second support being positioned offset to each other; and
the first support and the second support being mounted in between the grasping panel and the base panel.

13. The wastebasket stand as claimed in claim 12 comprising:
a ledge;
the ledge being positioned coplanar with the grasping panel; and
the ledge being connected adjacent to the grasping panel.

14. The wastebasket stand as claimed in claim 12 comprising:
the first support and the second support each comprising an inner wall, an outer wall, a first height-adjustable pole, and a second height-adjustable pole;
the outer wall being connected perpendicular to the grasping panel;
the inner wall being connected perpendicular to the base panel;
the first height-adjustable pole and the second height-adjustable pole being positioned offset from the outer wall;
the first height-adjustable pole and the second height-adjustable pole being positioned opposite to each other across the outer wall;
the first height-adjustable pole and the second height-adjustable pole being terminally connected to the grasping panel;
the first height-adjustable pole and the second height-adjustable pole being terminally connected to the base panel, opposite the grasping panel; and
the inner wall being slidably engaged in between the first height-adjustable pole, the second height-adjustable pole, and the outer wall.

15. The wastebasket stand as claimed in claim 12 comprising:
a switch;
a battery;
a light;
the switch, the battery, and the light being positioned within the foot-receiving channel;
the switch, the battery, and the light being mounted onto the base panel; and
the light being electrically connected to the battery through the switch.

16. The wastebasket stand as claimed in claim 12 comprising:
the basket-attachment mechanism comprising a plurality of adhesive strips;
the plurality of adhesive strips being positioned parallel and offset from each other; and
the plurality of the adhesive strips being distributed across the base panel.

17. The wastebasket stand as claimed in claim 12 comprising:
the basket-attachment mechanism comprising a plastic bonding agent; and
the plastic bonding agent being positioned on the base panel.

18. The wastebasket stand as claimed in claim 12 comprising:
the basket-attachment mechanism comprising a first wing, a second wing, a first linear actuator, and a second linear actuator;
the first wing being connected perpendicular and adjacent to the base panel;
the second wing being connected perpendicular and adjacent to the base panel, opposite the first wing;
the first linear actuator being operatively integrated into the first wing, wherein the first linear actuator is used to generate an inward pressing force from the first wing;
the second linear actuator being operatively integrated into the second wing, wherein the second linear actuator is used to generate an inward pressing force from the second wing;
the first linear actuator and the second linear actuator being positioned collinear to each other;
the first linear actuator and the second linear actuator each comprising a male-threaded rod, a wind head, a female-threaded hole, and an end stopper;
the wing head being terminally connected to the male-threaded rod;
the end stopper being terminally connected to the male-threaded rod, opposite the wing head;
the female-threaded hole of the first linear actuator traversing through the first wing;
the female-threaded hole of the second linear actuator traversing through the second wing; and
the male-threaded rod being engaged through the female-threaded hole.

19. The wastebasket stand as claimed in claim 12 comprising:
the grasping panel comprising a plurality of grips; and
the plurality of grips being attached on the grasping panel, opposite the foot-receiving channel.

20. The wastebasket stand as claimed in claim 12 comprising:
the grasping panel comprising a plurality of lockable wheels; and
the plurality of lockable wheels being detachably attached on the grasping panel, opposite the foot-receiving channel.
